(19) United States
(12) Patent Application Publication
(10) Pub. No.: US 2026/0046504 A1
(43) Pub. Date: Feb. 12, 2026

(54) CLEANLINESS INSPECTION SYSTEM FOR INSPECTION OF AN INNER SPACE OF MOBILE TRANSPORT TANKS

(71) Applicant: ScanTank B.V., Bergambacht (NL)

(72) Inventor: Abel Noordanus, Bergambacht (NL)

(73) Assignee: ScanTank B.V., Bergambacht (NL)

(21) Appl. No.: 19/099,881

(22) PCT Filed: Aug. 1, 2023
(86) PCT No.: PCT/EP2023/071304

§ 371 Date: Jan. 30, 2025

(30) Foreign Application Priority Data
Aug. 1, 2022 (NL) 2032654

(51) Int. Cl. H04N 23/50; H04N 23/51; H04N 23/52; H04N 23/56

(52) U.S. Cl. CPC H04N 23/555; H04N 23/51; H04N 23/52; H04N 23/56

(57) ABSTRACT

Cleanliness inspection system for inspection of mobile transport tanks, such as tank containers and tank trailers, comprising: a support structure; an inspection unit, connected to the support structure, comprising an aligner to be aligned with an opening of a mobile transport tank, a housing that delimits an inner space, and a camera movable with respect to the support structure between an idle position, in which the camera is arranged within the inner space and an inspection position, in which the camera protrudes through the opening to capture footage of an inner space of a mobile transport tank upon alignment of the aligner with the opening, and a contamination detector, operatively connected to the camera, wherein the camera is configured to, in the inspection position, capture footage in predefined measurement directions associated with a contamination risk area in a mobile transport tank, and wherein the contamination detector is configured to determine foreign contamination, such as moisture or fluid residue, in the mobile transport tank on the basis of the captured footage, and to provide a contamination signal representative for the determined contamination.

### FIELD OF THE INVENTION

The present invention relates to a cleanliness inspection system for inspection of an inner space of mobile transport tanks, such as tank containers, tank trailers and tank wagons. The invention further relates to a loading gantry for mobile transport tanks, a method for cleanliness inspection of mobile transport tanks, and a method for providing a loading gantry for mobile transport tanks, such as tank containers, tank wagons and tank trailers.

### BACKGROUND OF THE INVENTION

Tank inspection systems are known for inspecting transport tanks to check if the transport tank has maintained structural integrity. Such checks are only done once or a few times over the lifetime of a tank and may take relatively long. An operator usually physically enters the tank, or alternatively, manually lowers a camera into a tank, and looks at a screen to see if the integrity of the tank, for example the welds, appears to be visually in order. Such an inspection is then usually followed by additional diagnostics, such as a pressure test, to verify the structural integrity.

DE102000049A1 discloses a mobile device for inspection and cleaning of fluid tanks. In an embodiment, the device comprises a telescopic arm having a tool head and a cleaning hose, a vacuum device and/or a camera. The tool head may be lowered into a fluid tank and images captured with the camera may be stored and/or shown to a user on a monitor.

A disadvantage of the manual inspection of the prior art, is that the situation in a mobile transport tank cannot always be properly distinguished. Not all positions in the tank can be seen with the equipment from the prior art. As a result, the inspection may be incomplete. This means that a user's assessment of the integrity or cleaning of the tank may be partially or fully incorrect.

Furthermore, the inspection is carried out during a planned structural inspection of the tank. The applicant has found that that the situation in the fluid tank at that time may differ substantially from the situation in the mobile transport tank at the time it is most important, i.e. just before filling the tank with product.

The mobile devices of the prior art require a relatively large amount of labour for positioning and installing the device on the tank and for inspecting the tank. Additionally, the manual movement of the camera inside the tank is relatively time-consuming. A user may manoeuvre the camera manually, as a result of which the intensity and precision of the inspection can vary substantially from tank to tank and from user to user.

As a result, known inspection systems are deemed insufficient for efficient, reliable or consistent assessment of cleanliness in an inner space of a mobile transport tank.

### OBJECT OF THE INVENTION

It is therefore an object of the invention to provide a cleanliness inspection system for inspection of inner space of mobile transport tanks, such as tank containers, tank trailers and tank wagons that at least partially overcomes the disadvantages of the prior art, or at least to provide an alternative cleanliness inspection system, for example a cleanliness inspection system that can be used efficiently, reliably and/or allows for a consistent assessment of cleanliness in a mobile transport tank.

### DESCRIPTION OF THE INVENTION

According to the present invention, this object is achieved by a cleanliness inspection system according to claim 1. The inspection system may be configured to inspect an inner space of mobile transport tanks, such as tank containers, tank trailers and tank wagons.

The inspection system comprises a support structure and an inspection unit, connected to the support structure. The inspection unit comprises an aligner to be aligned with an opening of a mobile transport tank, such as a manlid opening. The inspection unit further comprises a housing, and a camera.

The camera is movable with respect to the support structure between an idle position, in which the camera is arranged within the housing and an inspection position, in which the camera extends at least partially from the housing such that the camera protrudes through the opening to capture footage of an inner space of a mobile transport tank upon alignment of the aligner with the opening.

The camera is configured to, in the inspection position, capture footage in at least one predefined measurement direction associated with a contamination risk area in a mobile transport tank.

The inspection system further comprises a contamination detector, operatively connected to the camera. The contamination detector is configured to detect foreign contamination, i.e. contamination due to external objects or substances, such as moisture, fluid residue or objects, in the mobile transport tank on the basis of the captured footage, and to provide a contamination signal representative for the detected contamination. In particular, the contamination detector is configured to detect, i.e. to determine that foreign contamination is present on the basis of the captured footage. The contamination detector may be configured to determine a contamination grade, for example a severeness of contamination, e.g. a number of contaminated areas, a total contaminated surface and/or another quantity representative for the amount, a contamination type, and/or other properties of the contamination. The contamination detector may comprise a footage processing unit configured to process the footage, for example to make the footage suitable for displaying and/or analysation, and a footage analysation unit configured to analyse the processed footage. For example, the contamination detector may be configured to determine the external object type and/or substance type. The contamination detector may analyse the captured footage to provide analysis results with respect to the contamination in the contamination signal.

The cleanliness inspection system may offer multiple benefits:

First of all, inspection may be performed relatively fast as the camera is configured to, in the inspection position, capture footage in at least one predefined measurement direction in the mobile transport tank.

Also, as the at least one measurement direction is predefined, the inspection may be relatively consistent for each inspected mobile transport tank.

Thirdly, by having a contamination detector, detection of contamination by a user may not be required. Contamination may be detected without human vigilance, such that an inspection result may be relatively consistent and does no longer necessarily depend on the user of the inspection system.

Further, the contamination detector may be able to detect contamination much more precisely as detection does not depend on visibility of contamination on a monitor.

Finally, the inspection system may require less labour due to the alignment of the aligner with the opening and the predefined measurement directions of the camera in the inspection position.

Therewith, the cleanliness inspection system may be used efficiently, reliably and may allow for a consistent assessment of cleanliness in a mobile transport tank.

The contamination risk areas may be predetermined areas inside a mobile transport tank. The at least one measurement direction may be defined by the camera, for example based on common contamination risk areas in a mobile transport tank.

The camera may be arranged rotatably with respect to the housing. The camera may be configured to rotate into at least one predefined measurement direction to capture footage in the at least one predefined measurement direction. The camera may be configured to rotate into multiple predefined measurement directions, for example consecutively, e.g., according to a predefined sequence. The at least one measurement direction and/or the sequence may be pre-programmed. Alternatively, the camera may be positioned fixed in the at least one predefined measurement direction. The camera may comprise multiple lenses arranged in respective multiple predefined measurement directions. Additionally or alternatively, the inspection unit may comprise multiple cameras.

The camera may be configured to capture footage using visible light. Additionally or alternatively, the camera may be configured to capture light in the non-visible spectrum. The camera may be provided with a light source, such as an white light source, an IR source and/or an UV source. The light source may comprise an LED and/or a laser source. The light source may emit light in the respective measurement direction of the camera. The light source may be configured to emit polarised light, for example tdddhrough a polarising filter. The light source may have a luminosity of at least 750 lumen, such as at least 1000 lumen. It has been found that sufficient luminosity may be advantageous for detecting contamination, as distinction between the foreign contamination and tank wall may be enhanced, e.g. by increased contrast and shadows, which is especially important when detecting moisture, e.g. in a relatively large tank. The camera may be configured to capture photos, videos, or other internal footage of the mobile transport tank.

The contamination detector may be configured to detect contamination on the basis of raw footage, be configured to process the footage before detecting contamination, e.g. in a footage processing unit, and/or may be configured to receive pre-processed footage from the camera. The contamination detector may be configured to perform image recognition.

The contamination detector may comprise an artificial intelligence algorithm, e.g. in a footage analysation unit. The artificial intelligence algorithm may be trained to detect foreign contamination within mobile transport tanks.

The contamination detector may be configured to be trained with machine learning. The artificial intelligence algorithm may comprise a neural network, support vector machine and/or hidden Markov model. In the past, it has been found to be difficult to identify contamination in a mobile transport tank, as inner spaces of mobile transport tanks may differ due to previous usage and wear, and even the inner space of the same mobile transport tank may differ due to lighting conditions. Therefore, detection of contamination by simply comparing footage with earlier footage of contamination on the basis of human-made comparison criteria does not always lead to the desired detection accuracy.

It has been found that an artificial intelligence algorithm may be particularly suited for identifying contamination on the basis of captured footage. As machine learning may be able to identify contamination on the basis of criteria that may not be noticed by humans, detection may be performed relatively accurately.

As the cleanliness inspection system may be suited to perform repetitive inspection of large numbers of mobile transport tanks, it may be relatively easy to obtain large numbers of footage on the basis of which the machine learning can be trained. This way, the contamination detector may be relatively reliable in detecting different types of contamination. By training the contamination detector, detection accuracy may be improved. In addition, it may be possible to train the contamination detector with new types of contamination, so that the contamination detector may be updated to be able to also detect the new types, e.g. new substances.

In contrast with prior art documents, the contamination detector may be configured to detect foreign objects and/or substances, e.g. not forming or having formed part of the tank itself. Therewith, detectable contamination may be less predictable such that a higher precision may be required compared to when known objects are inspected, such as when inspecting welding seams or the tank wall itself.

In an embodiment, the cleanliness inspection system is configured to provide a filling approval for the mobile transport tank when the contamination signal is below a predefined threshold.

The cleanliness inspection system may be configured to be mounted on a fluid loading gantry. This way, the inspection may be performed just before filling the mobile transport tank.

The support structure may be shaped as a fluid loading arm. This way, the inspection system may be mounted to a fluid loading gantry like a common fluid loading arm, for example a loading arm for loading liquids into a mobile transport tank.

The support structure may be fixed to the ground. In particular, the support structure may be positioned above or next to a mobile transport tank parking location.

By performing the inspection at the fluid loading gantry, fluid may be loaded subsequently after inspecting the inner side of a mobile transport tank. This way, a filling approval may indicate whether product may be loaded into the tank after inspection. As such, loading a contaminated tank with fluid may be avoided. The product may be a liquid, such as foodstuffs, industrial products, fuels or oils. The product may be solid matter, e.g. dry matter such as a powder or granulate, a gas, or mixtures of any of the previous. The support structure may be shaped accordingly, e.g. as a dry matter loading arm. Embodiments of the invention will be explained below referring to a fluid, in particular a liquid.

In an embodiment, the camera is configured to start capturing footage when moved in the inspection position. This way, the inspection may be performed fast. In an embodiment, the cleanliness inspection system comprises a logging unit configured to log the cleanliness inspection signal and/or the filling approval. The inspection position may be located vertically underneath the idle position when the aligner is aligned with the opening, for example located at a predefined distance from the idle position, for example 0.5-2.5 m from the idle position. The camera may be rotatable in the inspection position, for example the camera may be rotatably mounted to the support structure. The camera may be rotatably mounted with respect to the aligner, such that the camera may rotate into the predefined measurement direction while the aligner may remain stationary with respect to the manlid. In particular, the camera may be rotatable with respect to the housing, such that the housing may remain stationary with respect to the tank.

The camera may be rotatable around a first axis. The first axis may be a vertical axis, such that footage may be captured in multiple measurement directions, while the support structure, housing and/or aligner remain stationary. This way, inspection may be performed relatively fast as less mass is rotated. In particular, the camera may comprise a rotatable mount with which the camera is rotatably mounted to the rest of the inspection unit that remains stationary. Alternatively or additionally, the camera may be rotatable around a second and/or a third axis, which may be axes perpendicular to the first axis, e.g. horizontal axes. This way, upper and/or lower parts of the tank may be imaged relatively precisely.

The camera may be configured to, in the inspection position, rotate into the measurement directions. This way, the amount of movable parts is reduced and inspection may be performed in the measurement directions by rotating the camera only. The camera may be configured to rotate into all the predefined measurement directions in the inspection position without translational movement into other positions.

The camera may comprise a lens and a condensation reduction device configured to prevent and/or reduce condensation on the lens when the camera is moved into the inner space. It has been found that, especially when inspecting upon cleaning, the relatively warm and/or humid inner space of the container may cause condensation on the camera lens and thereby hamper detection of contamination.

The condensation reduction device may be configured to remove condensation of the lens of the camera by mechanical action, pneumatically or in another way, or may be configured to limit and/or avoid condensation, for example by adjusting the temperature of the lens to a temperature of the inner space. The condensation reduction device may comprise an anti-condensation coating, a windscreen wiper, a heating element and/or a fan.

Alternatively, the inspection unit may be provided with heating, for example in the housing, to adjust the temperature of the camera. The camera may be heated and/or cooled before, during and/or after moving between the idle position and the inspection position.

In an embodiment, the camera comprises a polarising filter configured to filter captured footage in a predetermined filter angle. Tank walls are made of relatively reflective material. When inspecting welds or surface defects, this effect is less pronounced as reflectivity is often reduced locally. However, foreign contamination, especially fluids and condensation, may also reflect light such that overexposure may hamper detection thereof. The polarising filter may have a circular polarisation and/or a liner polarisation or another polarisation. It has been found that by polarising incident light, contrast, saturation and/or crispiness may be improved, resulting in improved contamination detection.

In an embodiment, the inspection unit comprises a light source configured to emit light polarised in a polarisation angle and wherein a difference between the polarisation angle and the filter angle is 5°-65°, for example 15°-45°. It has been found that contamination, especially moisture, may be detected better in a tank, presumably due to less reflection at a higher polarisation angle difference. However, when the difference would be 90°, almost no light from the light source would be captured and the lighting would be relatively inefficient. Preferably, the polarisation angle is 25°-35° away, such as approximately 30° away from the filter angle, for example at a light source having a luminosity of 750-1500 lumen.

In an embodiment, the camera is configured to, in the inspection position, capture footage in multiple predefined measurement directions that are associated with multiple contamination risk areas in the mobile transport tank. As such, a thorough inspection may be performed. The measurement directions may be opposite to each other, for example, the measurement directions may opposite with respect to a vertical symmetry plane. This way, remote contamination risk areas in the mobile transport tank may be inspected from a single inspection position. In particular, the measurement directions may be opposite to each other along the longitudinal direction of the tank.

The camera may be configured to, in the inspection position, capture footage in a forward measurement direction and in a backward measurement direction of the transport tank. The forward and rearward directions may e.g. be defined by positioning of the support structure, such that a forward direction of a tank corresponds to the forward direction of the camera and vice versa.

In an embodiment, the camera is configured to, from the inspection position, capture footage in upward measurement directions that are opposite to each other with respect to a vertical symmetry plane, e.g. a plane perpendicular to the longitudinal axis of the container, such as in forward and backward direction of the tank. Condensation and/or moisture was especially difficult to detect on the upper side of a container in the past. It has been found that, in contrast with prior art units that are configured to move past weld seams to check integrity, the inspection system may advantageously enable fast inspection of the upper wall from the inspection position. The camera may be configured to rotate into the upward measurement directions that are opposite to each other in the inspection position, for example without movement of the support structure, the inspection unit and/or the aligner. This way, the rotation mechanism may be relatively light such that rotation may be performed quickly from the inspection position.

In an embodiment, the cleanliness inspection system is configured to determine a tank type, and the cleanliness inspection system is further configured to determine the multiple predefined measurement directions in dependence of the determined tank type. It has been found that the contamination risk area differ per type of tank.

The tank type may be retrieved from an information source, e.g. a database, may be input by an operator, e.g. via a control interface, and/or may be determined automatically, e.g. by measuring dimensions of the tank and/or on the basis of the mobile tank identifier recognized by a recognition system. As different tank types may be provided with different types of interior, e.g. baffles, bulkhead dividers, piping, inlets and/or outlets, the contamination risk areas may vary with tank type.

In an embodiment, the contamination detector is configured to detect condensation on walls of a mobile transport tank on the basis of the captured footage as contamination. It has been found that condensation on walls was relatively hard to detect in the prior art.

The camera may be configured to capture footage in an upward measurement direction, and the contamination detector may be configured to detect condensation on an upper, bottom and/or side tank wall. The camera may be configured to rotate into the upward measurement direction and/or be mounted in the upward measurement direction. For example, the camera could be configured to rotate into the upward measurement direction when arranged in the inspection position.

Upper tank wall, as used herein, may be understood as being an upper part or area of the tank wall, for example an upper circular arc of the tank wall of a mobile transport tank having a circular cross section, for example, a circular arc having a centre angle up to approximately 45 degrees on both sides of a vertical centre axis. Similarly, side tank wall may be understood as being a part or area of the tank wall extending at least partially downwards away from the upper wall, for example a circular arc of the tank wall of a mobile transport tank having a circular cross section, for example, a circular arc having a centre angle up to approximately 45 degrees on both sides of a horizontal centre axis.

It has been found that upon cleaning a mobile transport tank, humidity in the tank may be relatively large. As such, condensation of fluid may occur on tank walls. Although this effect has not been regarded in the prior art, it has been found that condensation may be a relatively important factor in assessing the cleanliness of a mobile transport tank. The upper or side tank walls may therefore be regarded as contamination risk areas. Condensation may subsequently flow downward towards the bottom tank wall.

In an embodiment, the camera is configured to capture footage in a substantially horizontal measurement direction and the contamination detector is configured to detect fluid accumulation or objects at a vertical tank baffle or tank end wall. A substantially horizontal measurement direction is to be understood as at least partially horizontal, for example such that footage may be captured in the longitudinal direction of the mobile transport tank, such as a measurement direction from the inspection position towards a vertical tank baffle or tank end wall. The tank end wall may be understood as being an end part or area of the tank wall in a longitudinal direction of the mobile transport tank, for example a front wall, tank baffle or rear wall of the mobile transport tank.

Especially when larger amounts of contamination are present in the mobile transport tank, contamination may accumulate at lower areas in the tank. Due to movement of the mobile transport tank, fluids may flow and accumulate near end walls or tank baffles. It has been found that by inspecting these contamination risk areas, a reliable inspection may be performed.

The opening may advantageously be a manlid opening of the mobile transport tank. Alternatively, the opening may also be another opening in a mobile transport tank that allows the camera of the inspection unit to protrude therethrough to capture footage of an inner space of the mobile transport tank, such as an inspection hatch opening. An inspection hatch may typically have a diameter of approximately 17 or 30 cm.

Advantageously, the opening is an opening suitable for loading a product into the mobile transport tank after inspection. This, way the same opening may be used for inspection and for subsequently loading a product. As such, inspection of the mobile transport tank requires relatively little labour and time, and inspection may be performed shortly before filling.

The opening may be a manlid opening. An advantage of a manlid opening is that its relatively large size provides flexibility with respect to the size and amount of sensors provided on the inspection unit. A manlid opening may, for example, have a diameter of 40-65 cm, such as 46, 50 or 60 cm. Furthermore, a manlid opening may usually be used for filling product into the mobile transport tank.

In an embodiment, the aligner has a conical shape adapted to mate to a contour of a standard mobile tank manlid opening. This way, the inspection system may be aligned with the transport tank conveniently.

The aligner may be configured to mate to the contour in such a way that passing of light through the manlid opening is limited when the camera is in the inspection position, for example in such a way that passing of light is substantially avoided. This may reduce the influence of ambient light, which can vary due to weather conditions and location and further allows for efficient inspection of the mobile transport tank.

In addition or alternative to limiting light passage, the aligner may comprise a polarising filter to polarise incident light. This way, incident light may advantageously be polarised in addition or alternative to polarised light from a light source.

The aligner may have a circular cross-section, but may also be provided with a non-circular cross section that mates with a contour of an opening in the transport tank. This way, mating may require rotation of the inspection unit in a plane of the manlid opening to improve alignment.

In an embodiment, the minimum diameter of the aligner is smaller than an outer diameter of the camera and wherein the aligner is provided with at least one recess to allow the camera to move through the aligner, for example wherein the minimum outer diameter is 0.6 m or less, preferably 0.3 m or less. The aligner may advantageously be configured to mate with multiple common standard manhole sizes, e.g. 0.3 m and 0.6 m.

For example, the minimum diameter may be 26 cm, whereas an outer diameter of the camera may be 29 cm, whereby a recess of 3 cm is provided on the outer circumference of the cone.

In an embodiment, the cleanliness inspection system comprises an actuation system, operatively connected to the housing and configured to move the camera between the idle position and the inspection position, and a control interface, configured to receive operator input to activate the actuation system to move the camera to the inspection position upon receiving the operator input and to activate the actuation system to move the camera back to the idle position after capturing footage.

The actuation system may be operatively connected to the camera on one outer end, and to the aligner and/or to the housing on another outer end, and for example comprise a pneumatic cylinder.

The control interface may be arranged on the support structure and/or on the inspection unit. By having the control interface arranged on the support structure and/or on the inspection unit, the control interface may be used by a user nearby, such as a driver. This way, inspection may be initiated by the user conveniently.

In a further embodiment, the control interface is configured to provide the contamination signal and/or the filling approval. This way, the control interface may provide an indication to the user whether the mobile transport tank may be filled upon inspection. As such, filling a contaminated transport tank may be avoided.

In an embodiment, the cleanliness inspection system comprises a locking system, configured to lock the inspection unit with respect to a manlid opening when the camera is in the inspection position. The inspection unit may be locked such that movement thereof is prevented with respect to a mobile transport tank, for example with respect to the manlid opening.

The locking system may comprise a pneumatic, hydraulic and/or electromechanical locking mechanism, such as a cylinder. The locking system may be arranged on the support structure to lock movement of the support structure with respect to the manlid opening when the camera is in the inspection position. The locking system may additionally or alternatively comprise a physical mechanism to lock the inspection unit to the mobile transport tank, such as a clamp or electromagnet.

The locking system may be operatively connected to the camera, the support structure and/or to an actuation system. The locking system may be configured to lock the inspection unit when the camera is away from the idle position and/or when the camera protrudes from the housing.

It has been found that moving the inspection unit when the camera is in the inspection position may be detrimental to the alignment and/or performance of the camera. Further, the footage captured with the camera may be influenced by movement. Therefore, the locking system may protect the camera from unwanted movement of the inspection unit and improve the contamination signal.

Additionally or alternative to a locking system, the cleanliness inspection system may comprise a movement sensor, configured to measure a motion signal representative for movement of the inspection unit with respect to a manlid opening. The movement sensor may comprise an inertial measurement unit, for example comprising an accelerometer, gyroscope, or magnetometer. The movement sensor may be operatively connected to the contamination detector and/or to the inspection unit to activate movement of the camera to the idle position when motion of the inspection unit is represented in the provided motion signal and/or to discard captured footage when motion of the inspection unit is represented in the provided motion signal.

In an embodiment, the cleanliness inspection system comprises a recognition system configured to recognize a mobile tank identifier, such as a container identification number, vehicle identification number and/or wagon identification number, and to associate the recognised identifier with the captured footage. In particular, the recognised identifier may be associated with the contamination signal.

This way, the contamination signal may be stored with the mobile tank identifier to enable reliable logging of cleanliness of the respective mobile transport tank.

Further, as contamination risk areas may depend on the mobile transport tank, the predefined measurement directions may be adjusted to the respective mobile transport tank. For example, the camera may be configured to adjust the predefined measurement directions on the basis of the mobile tank identifier.

In an embodiment, the inspection unit comprises a temperature sensor configured to measure a temperature signal representative for a tank wall temperature, for example wherein the contamination signal is dependent on the temperature signal.

It has been found that due to cleaning, a mobile transport tank wall may have a relatively high temperature, which may be unwanted when filling the mobile transport tank. High temperatures may be unwanted, in particular when filling fluids having a relatively low flash point, when filling explosive fluids and/or when filling fluids that may be prone to oxidation.

By checking tank wall temperature, filling a mobile transport tank that has an elevated wall temperature above a predefined threshold may be avoided.

The temperature signal may comprise the tank wall temperature.

The temperature sensor may be operatively connected to the contamination detector.

The temperature sensor may comprise a remote-sensing thermometer, for example a pyrometer such as an infrared thermometer. This way, a wall temperature may be measured without physical contact, for example from the inspection position. The temperature sensor may be attached to the inspection unit. For example, the temperature signal may be measured in a fixed direction. The temperature sensor may also be attached to the camera to rotate with the camera such that the temperature signal is measured in the measurement direction of the camera.

In an embodiment, the contamination detector is configured to provide the contamination signal in dependence of the temperature signal. The contamination detector may be configured to compare the wall temperature with the predefined threshold.

In an embodiment, the inspection unit comprises a gas sensor configured to measure a residual gas concentration in a mobile transport tank, wherein the cleanliness inspection system is configured to block provision of a filling approval for the mobile transport tank when the residual gas concentration exceeds a predetermined concentration.

It has been found that contamination by residual gases in the mobile transport tank may be unwanted and is potentially unsafe for workers and/or the environment. By checking gas concentrations present in the tank, filling a mobile transport tank that has residual gases may be avoided or limited to improve a safe work environment.

In an embodiment, the contamination detector is configured to provide the contamination signal in dependence of the residual gas concentration. The contamination detector may be configured to compare the residual gas concentration with a predefined threshold. This way, an alarm may be provided such that safety in the working environment is improved.

The mobile transport tank may be moved towards the inspection system, for example by being parked nearby the inspection system. However, movement may cause imprecision with regards to alignment of the camera with respect to the mobile transport tank. As such, the contamination signal could potentially be influenced by movement of the mobile transport tank, and repeatability of the contamination signal may be influenced by differences in orientation of the mobile transport tank.

The at least one measurement direction may be associated with a contamination risk area in a mobile transport tank on the basis of an expected orientation of the mobile transport tank. Therefore, an orientation of the mobile transport tank that differs from the expected orientation may potentially result in captured footage that is not or less associated with a contamination risk area.

In an embodiment, the cleanliness inspection system is provided with an alignment mark, that indicates an expected alignment of the inspection unit with respect to a mobile transport tank. The alignment mark may for example comprise a line, arrow or handle that indicates an expected direction of a mobile transport tank.

In an embodiment, the cleanliness inspection system comprises an orientation compensation unit configured to provide an orientation signal representative for an orientation of a mobile transport tank with respect to the aligner, wherein the cleanliness inspection system, e.g. the camera, is configured to adjust the at least one predefined measurement direction on the basis of the orientation signal.

The orientation compensation unit may be configured to compensate orientation of the tank around a vertical axis. Especially for tank trucks, which may be driven manually, variations in position with respect to the support structure may be compensated this way. Additionally or alternatively, the orientation compensation unit may be configured to compensate orientation of the tank around a horizontal axis, for example due to tank or terrain being non-horizontal.

The orientation compensation unit may be configured to determine an orientation of the transport tank, for example through visual recognition. The orientation compensation unit may be operatively connected to the camera to determine the orientation signal based on structural elements of the transport tank in the captured footage.

The orientation compensation unit may for example comprise an accelerometer, gyroscope, magnetometer, digital compass and/or an optical device configured to optically recognise a position of the mobile transport tank, such as an orientation camera provided on the support structure. Additionally or alternatively, the orientation compensation unit may be configured to determine the orientation signal on the basis of captured footage, for example by image recognition, e.g. by recognition of tank end walls, tank top and/or bottom walls, bulkhead dividers, and/or tank inlets or outlets.

In particular, the orientation compensation unit may be configured to determine a location of a tank outlet. It has been found that the tank outlet is located on a similar position in different transport tanks and therefore provides an efficient orientation indication.

By having an orientation signal, the at least one measurement direction of the camera may be adjusted to the orientation of the mobile transport tank to improve the contamination signal.

In particular, the contamination signal may be improved by discarding footage and capturing new footage in another orientation of the mobile transport tank. Alternatively, the captured footage may be adjusted by transforming the footage, for example by cropping, translating and/or rotating the footage, e.g. using software. Additionally or alternatively, the camera may be configured to adjust the at least one measurement direction by compensating at least one measurement direction for the orientation signal, for example the camera may rotate into at least one orientation-compensated measurement direction that accounts for the respective orientation difference with an expected orientation of the mobile transport tank.

The camera may be configured to, first capture footage in an expected longitudinal direction of the tank, wherein the orientation compensation unit is configured to determine an actual longitudinal direction of the basis of deviation from the expected longitudinal direction of the tank in the captured footage. The camera may further be configured to, subsequently, capture footage on the basis of the actual longitudinal direction, for example by capturing in multiple measurement directions that are opposite to each other along the actual longitudinal direction of the tank, or measurement directions that have opposite components along the actual longitudinal direction of the tank.

In an embodiment, the cleanliness inspection system comprises a fluid level protector configured to measure a fluid level signal representative for a fluid level in the mobile transport tank, wherein the fluid level protector is configured to activate movement of the camera towards the idle position and/or to block movement of the camera towards the inspection position when the fluid level signal exceeds a predetermined fluid level threshold. The fluid level protector may be operatively connected to the actuation system and/or to the locking system.

The fluid level protector may comprise a fluid level sensor, for example a distance sensor configured to measure a downward distance. The fluid level threshold may be based on an expected height of a bottom wall of a mobile transport tank. Fluid level protector may comprise a distance sensor, such as an ultrasound, optical or electric distance sensor.

The camera may not be suited to be submerged in fluid. By checking whether a fluid level in the mobile transport tank is below a level of the inspection position, immersion of the camera in a fluid may be avoided.

In an embodiment, the support structure is constructed as a fluid loading arm. By having a fluid loading arm, the inspection may be performed as a fluid loading.

The support structure may be a balanced fluid loading arm, such that movement of the fluid loading arm may be performed with relatively little force. This way, the inspection unit may be aligned with a manlid opening relatively easily to speed up the inspection procedure.

The fluid loading arm may be a movable vertically only, like a telescopic fluid loading arm, or both vertically and horizontally, for example like a swivel able fluid loading arm.

The support structure may also be constructed as a bottom or side loading arm and be movable correspondingly.

According to an aspect, the invention relates to a use of a cleanliness inspection system and/or a loading gantry according to any of the embodiments disclosed herein for determining whether a tank has been cleaned according to predetermined standards.

According to another aspect, the invention provides a loading gantry, such as a top loading gantry, for mobile transport tanks, such as tank containers and tank trailers, comprising a walkway positioned at least partially above a mobile transport tank parking location allowing operators to reach a manlid opening of a mobile transport tank positioned on the transport tank parking location and a cleanliness inspection system according to any of the embodiments disclosed herein.

The loading gantry may provide similar benefits as the inspection system as described herein.

In addition to the cleanliness inspection system, the loading gantry may comprise one or more loading arms. This way, the mobile transport container may be loaded directly after inspecting. Additionally or alternatively, the one or more loading arms may be configured to be activated in dependence of the contamination signal. As such, loading of a mobile transport container having contamination may be avoided.

In an embodiment, the loading gantry is provided with a mobile transport tank parked on the mobile transport tank parking location.

According to another aspect, the invention provides a method for cleanliness inspection of mobile transport tanks, such as tank containers and tank trailers, comprising the steps of:
providing an inspection unit connected to a support structure;
aligning an aligner of the inspection unit with a manlid opening of a mobile transport tank;
moving a camera of the inspection unit from an idle position, in which the camera is arranged in an inner space of a housing into an inspection position, in which the camera protrudes through the manlid opening;
capturing footage with the camera from the inspection position in at least one predefined measurement direction associated with a contamination risk area in the mobile transport tank;
detecting contamination, such as moisture, in the mobile transport tank on the basis of the captured footage; and
providing a contamination signal representative for the detected contamination.

The method may provide similar benefits as the inspection system as described herein.

In an embodiment, the method comprises the step of providing a filling approval for the mobile transport tank when the contamination signal is below a predefined threshold.

In an embodiment, the method comprises the steps of: retrieving previous tank content data; providing subsequent tank content data; and providing a filling approval for the mobile transport tank when the contamination signal exceeds the predetermined threshold on the basis of previous tank content data and subsequent tank content data. Normally, no filling approval would be given if a certain amount of contamination is detected. However, if the previous contents of the tank do not interfere with expected new contents from the subsequent tank content data, the filling approval may still be provided. E.g. the previous contents may be similar, not reactive and/or compatible in another way.

It has been found that, even when contamination is found, a tank may be filled without additional cleaning if previous tank contents were similar to or compatible with a new fluid that is to be filled in the container. This way, the amount of additional cleaning to remove detected contamination before filling the tank may be reduced and/or no additional cleaning may be necessary.

In an embodiment, the contamination comprises moisture, condensation, fluid residue and/or objects.

In an embodiment, the step of detecting contamination comprises detecting condensation on walls of the mobile transport tank on the basis of the captured footage and/or detecting fluid accumulation at a vertical tank baffle or tank end wall on the basis of the captured footage. In an embodiment, the method comprises the step of filling the mobile transport tank with product when a filling approval has been provided for the mobile transport tank. The step of filling may be performed relatively short after provision of the filling approval, for example within several days, hours, such as within an hour.

When inspection is performed just before filling, a relatively high confidence on the degree of cleanliness of the tank at the moment of filling can be achieved.

The step of filling of the tank may be performed at the same site as the step of capturing footage. However, when performed at the same site, time available may be limited in order not to diminish the tank filling capacity at the site. According to the invention, inspection is performed from the inspection position, such that time for moving a camera between multiple inspection positions is reduced.

In an embodiment, the method is performed using the cleanliness inspection system according to any of the embodiments disclosed herein.

According to an aspect, the invention provides a non-volatile storage medium for a cleanliness inspection system according to any of the embodiments disclosed herein, storing a machine readable instruction to perform the steps of detecting contamination, such as moisture, in the mobile transport tank on the basis of the captured footage and providing a contamination signal representative for the detected contamination.

According to another aspect, the invention provides a loading gantry for mobile transport tanks, such as tank containers and tank trailers, with a cleanliness inspection system according to any of the embodiments disclosed herein. In an embodiment, the cleanliness inspection system may be provided on an existing loading gantry.

The cleanliness inspection system may be especially advantageous on loading gantries for mobile transport tanks.

### BRIEF DESCRIPTION OF DRAWINGS

Further characteristics of the invention will be explained below, with reference to embodiments, which are displayed in the appended drawings, in which:

FIG. 1 schematically depicts a perspective view of a loading gantry according to an embodiment of the present invention;

FIG. 2 schematically depicts a top view of the loading gantry of FIG. 1;

FIG. 3A schematically depicts a rear view of a cross section along line A-A of FIG. 2;

FIG. 3B schematically depicts a detailed view of the encircled section C of FIG. 3A;

FIG. 4A schematically depicts an inspection unit of a cleanliness inspection system according to an embodiment of the present invention; and

FIG. 4B schematically depicts a longitudinal cross section of the inspection unit of FIG. 4A.

Throughout the figures, the same reference numerals are used to refer to corresponding components or to components that have a corresponding function.

### DETAILED DESCRIPTION OF EMBODIMENTS

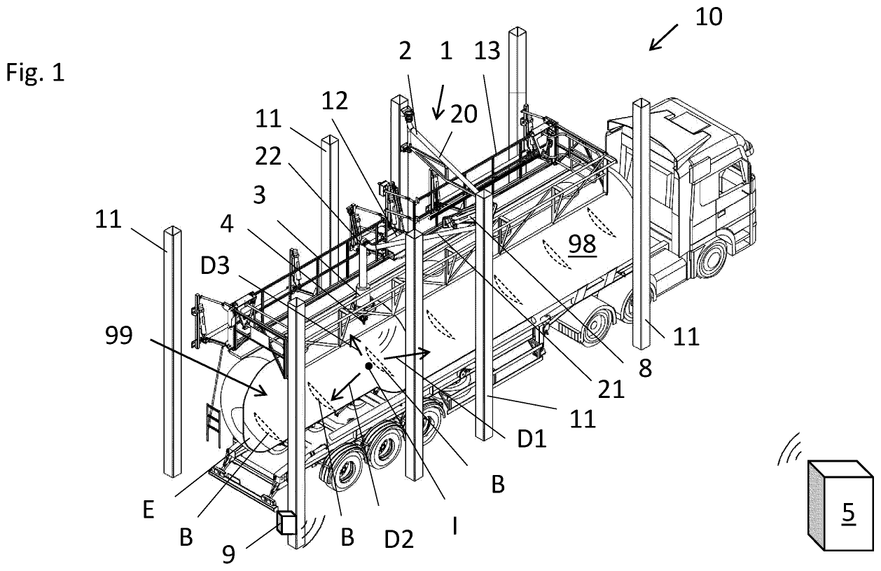

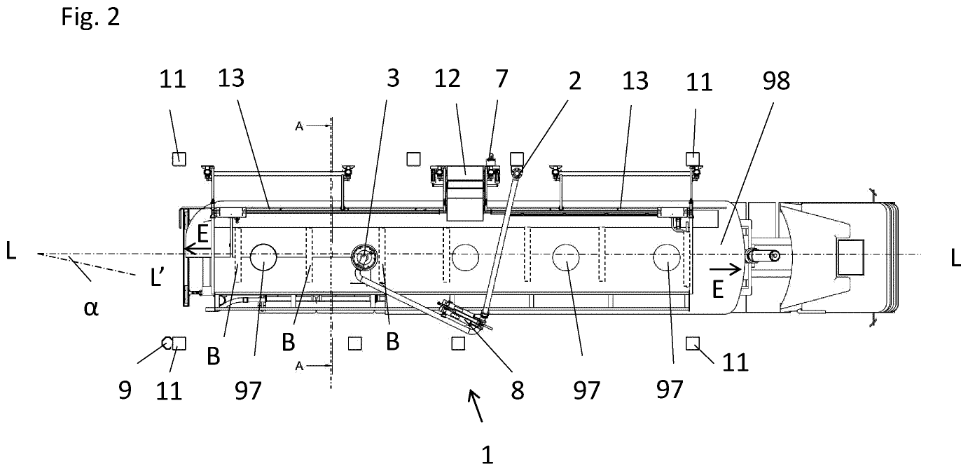

FIG. 1 schematically depicts a perspective view of a loading gantry 10 for mobile transport tanks, according to an embodiment of the present invention. The loading gantry 10 comprises a cleanliness inspection system 1 configured to inspect the inner space of mobile transport tanks 98, and a walkway 12 positioned at least partially above a mobile transport tank parking location allowing operators to reach a manlid opening 97 of a mobile transport tank positioned on the transport tank parking location. The walkway 12 comprises safety guardrails 13

The loading gantry 10 comprises a plurality of uprights 11 from which one or more fluid loading arms (not shown) are suspended for loading fluids into a mobile transport tank 98.

The inspection system 1 comprises a support structure 2 and an inspection unit 3 connected thereto. The support structure 2 is shaped as a fluid loading arm, having a first arm section 20, a second arm section 21 and a coupling section 22 connected to the inspection unit 3. The upright 11, the first arm section 20, second arm section 21 and the coupling section 22 are rotatably connected to each other to allow movement of the inspection unit 3 towards a manlid opening 97.

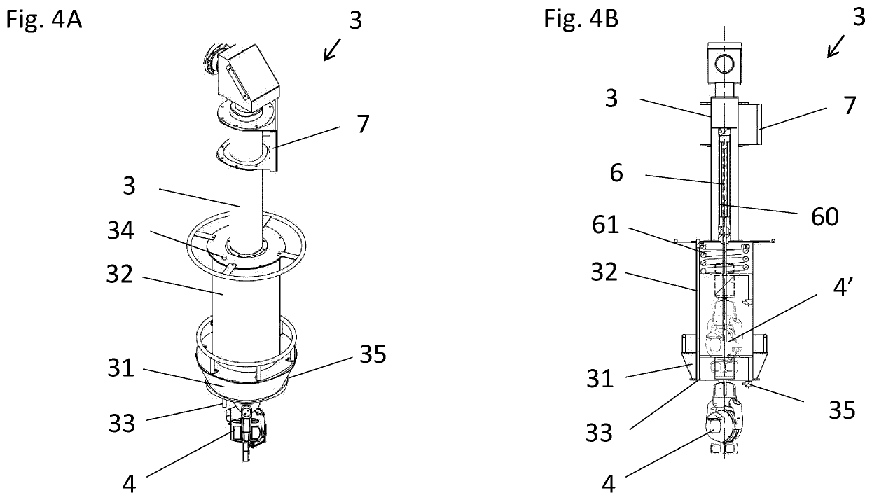

The inspection unit 3 comprises an aligner 31 to be aligned with a manlid opening 97 of a mobile transport tank, a housing 32 and a camera 4 movable with respect to the support structure 2. An embodiment of the inspection unit 3 is depicted in FIGS. 4A, 4B. The aligner 31 has a conical shape adapted to mate to a contour of the manlid opening 97 such that light passing through the manlid opening is limited when the camera 4 is in in the inspection position I, in particular substantially avoided. The aligner 31 has a circular cross-section but may also have another cross section.

The camera 4 is movable between an idle position, in which the camera is arranged within the housing 32, as depicted as camera 4′ in dashed lines in FIG. 4B, and an inspection position, in which the camera 4 protrudes out of the housing, as depicted with solid lines in FIGS. 4A and 4B, through the manlid opening 97 to capture footage of an inner space 99 of a mobile transport tank 98 upon alignment of the aligner 31 with the manlid opening 97.

The inspection position is located vertically underneath the idle position when the aligner is aligned with the opening, at a distance determined by actuation system 6.

In FIG. 4B, a minimum diameter of the aligner 31 cone is larger than an largest outer diameter of the camera 4. However, alternatively, the minimum diameter of the aligner 31 could also be smaller than an outer diameter of the camera 4 and the aligner 31 could then be provided with at least one recess to allow the camera to move through the aligner, for example wherein the minimum outer diameter is 0.3 m or less.

The camera comprises a lens and a condensation reduction device configured to prevent and/or reduce condensation on the lens when the camera is moved into the inner space. The condensation reduction device comprises an anti-condensation coating, a windscreen wiper, and a lens heating element.

The camera 4 comprises a polarising filter configured to filter captured footage at a filter angle and the LED light source is configured to emit light polarised in a polarisation angle that is at 15°-45° away from the filter angle, in particular 25°-35° away, such as approximately 30° away from the filter angle.

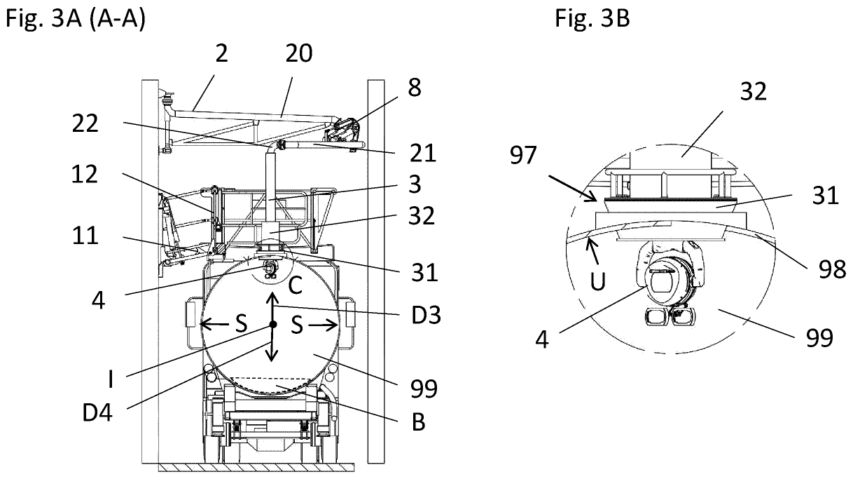

The inspection position I is located in the inner space 99 and may be in the middle of the height of the tank 98, as shown in FIG. 3A, or at another height. The inspection position I may be different than shown, for example be lower or higher to be further away from, respectively closer to the housing. The inspection position may for example depend on the type of transport tank. In particular, the inspection position may be higher in the tank, and for example be the position of the camera 4 as depicted in FIG. 3B.

The transport tank 98 comprises end surfaces E and vertical baffles B that are arranged in the transport tank 98. It has been found that edges E of the end surfaces and vertical baffles B may be contamination risk areas.

The camera 4 is rotatably arranged with respect to the housing 32 and is configured to, in the inspection position I, consecutively rotate into the predefined measurement directions D1, D2, D3, D4 associated with contamination risk areas in a mobile transport tank.

The contamination detector 4 is configured to determine that foreign contamination is present on the basis of the captured footage and configured to determine a contamination grade, in particular a severeness of contamination, such as a number of contaminated areas, a total contaminated surface and another quantity representative for the amount. The contamination detector 4 a contamination type, and other properties of the contamination. The contamination detector 4 comprises a footage processing unit configured to process the footage to make the footage suitable for displaying and analysation, and a footage analysation unit configured to analyse the processed footage. The contamination detector 4 is configured to determine the external object type and/or substance type. The contamination detector is configured to analyse the captured footage to provide analysis results with respect to the contamination in the contamination signal. The sequence and the measurement directions are pre-programmed. Upon rotation in each measurement direction, the camera is configured to automatically capture a photo and/or a video in each of the directions D1, D2, D3, D4. The camera 4 is configured to capture footage in upward measurement directions D3, D4 and in substantially horizontal measurement directions D1, D2 that are opposite to each other with respect to a vertical symmetry plane. The camera 4 is provided with an IR light and a LED white light illuminator having a luminosity of at least 750 lumen, such as at least 1000 lumen.

The inspections system 1 comprises an actuation system 6 comprising a pneumatic cylinder 60 operatively connected to the inspection unit 3 on one outer end, and to the camera 4 on another outer end. The actuation system 6 is configured to move the camera 4 between the idle position as depicted as camera 4′ in dashed lines in FIG. 4B, and the inspection position I. The camera is rotatably mounted with respect to the aligner 31 around a first, vertical axis, formed by the longitudinal axis of the actuation system 6, and around a second axis perpendicular to the first axis, in this embodiment a horizontal axis. In the inspection position, the camera 4 rotates along the first and second axes into the measurement directions.

The inspection system 1 comprises a contamination detector 5, operatively connected to the camera 4, for example via a wired or wireless connection, such as an internet connection and/or a mobile phone network connection. The contamination detector 5 may also be located remotely, for example be a cloud service.

The contamination detector 5 is configured to pre-process the footage received from the camera and to perform image recognition on the pre-processed footage. The contamination detector 5 comprises an artificial intelligence algorithm having a neural network trained to detected contamination within mobile transport tanks and is configured to detect foreign objects and/or substances as contamination, e.g. moisture and condensation, fluid residue and objects, on the upper wall U, side walls S, end walls E and baffles B in the mobile transport tank on the basis of the captured footage, and to provide a contamination signal representative for the detected contamination.

The contamination detector 5 is trained to detect condensation on the upper wall U and to detect fluid accumulation or objects at tank baffles B or end walls E. However, the contamination detector 5 may also be trained to detect other types of contamination and/or to detect contamination in other areas of a mobile transport tank. The contamination detector 5 comprises a logging unit configured to log the cleanliness inspection signal and the filling approval in a storage medium, such as in a local or remote storage medium e.g. in a memory module.

The inspection system 1 comprises a control interface 7 arranged on the inspection unit 3 configured to receive operator input to activate the actuation system 8 to move the camera between the inspection position I and the idle position. Additionally or alternatively, a control interface 7 may be arranged elsewhere on the loading gantry 10, such as on the walkway 12 or on the support structure 2. The control interface 7 may comprise buttons, keys, a touch screen, or other user input devices.

The cleanliness inspection system 1 is configured to provide a filling approval for the mobile transport tank 98 via the control interface 7 when the contamination signal is below a predefined threshold. For example, a filling approval may be provided via a visual signal on a display and/or a sound signal via a speaker.

The inspection unit 3 comprises a sensor unit 33 having a temperature sensor configured to measure a temperature signal representative for a tank wall temperature. The temperature sensor is for example an infrared thermometer operatively connected to the contamination detector. The contamination signal is dependent on the temperature signal. The contamination detector 5 is configured to provide the contamination signal in dependence of the temperature signal by comparing the wall temperature with the predefined threshold.

The sensor unit 33 of the inspection unit 3 comprises a gas sensor configured to measure a residual gas concentration in the mobile transport tank 98. The contamination detector 5 is configured to provide the contamination signal in dependence of the residual gas concentration by comparing the residual gas concentration with a predefined threshold. In particular, the cleanliness inspection system 1 is configured to block provision of a filling approval for the mobile transport tank when the residual gas concentration exceeds a predetermined concentration.

The inspection unit 3 comprises a fluid level protector comprising a fluid level sensor 35 configured to determine a fluid level signal representative for a fluid level in the mobile transport tank. The level sensor 35 is a laser distance sensor that measures a downward distance. The fluid level protector is configured to activate movement of the camera 4 towards the idle position and/or to block movement of the camera towards the inspection position when the fluid level signal exceeds a predetermined fluid level threshold. The fluid level protector is operatively connected to the actuation system 6. The level sensor 35 is a laser distance sensor but may also be another optical sensor or other type of sensor.

The temperature sensor, gas sensor and level sensor may be provided combined in a sensor unit 3, or individually and/or be located on different locations on the inspection system 1. The thresholds may be pre-programmed and/or may, for example, depend on the type of mobile transport tank, or fluid to be provided in the mobile transport tank. The contamination detector 5 may be configured to determine the threshold based on a mobile tank identifier.

The cleanliness inspection system 1 comprises an orientation compensation unit 34, configured to provide an orientation signal representative for an orientation of a mobile transport tank 98 with respect to the aligner 31 around a vertical axis. The orientation signal may additionally or alternatively be representative for an orientation around a horizontal axis. The orientation compensation unit 34 is configured to determine an orientation of the transport tank through visual recognition and is operatively connected to the camera to determine the orientation signal based on structural elements of the transport tank in the captured footage. The camera 4 is configured to adjust the at least one predefined measurement direction D1, D2, D3, D4 on the basis of the orientation signal, by compensating the at least one measurement direction for the orientation signal. The orientation compensation unit 34 comprises a digital compass having a magnetometer, but may additionally or alternatively comprise an accelerometer, gyroscope and/or an optical device configured to optically recognise a position of the mobile transport tank 98. For example, the compensation unit 34 may be connected to the camera to determine the orientation signal on the basis of captured footage, for example by detecting a location of a tank outlet in the tank. The camera may first capture footage in an expected longitudinal direction L-L, on the basis of which the actual orientation L-L′ of the tank may be determined.

The forward measurement direction D1 and rearward measurement direction D2 are opposite to each other along the actual longitudinal direction of the tank. The camera 4, in the inspection position, is configured to capture footage in measurement directions D1, D2 that are opposite to each other with respect to a vertical symmetry plane that is perpendicular to the longitudinal direction L-L of the tank.

This way, a difference in orientation of the transport tank 98, for example when the mobile transport tank is positioned with respect to the gantry 10 such that a longitudinal axis L-L′ of the transport tank 98 would differ with an angle a from an expected longitudinal axis L-L, the measurement directions D1, D2 of the camera 4 may be adjusted, e.g. in correspondence with the angle a. In this embodiment, the angle a is measured by the digital compass and the camera 4 is configured to compensate the at least one measurement direction by adding the rotation with angle a thereto, to obtain an orientation-compensated measurement direction and to rotate into the at least one orientation-compensated measurement direction.

The inspection system 1 comprises a locking system 8 arranged on the support structure 2. The locking system 8 comprises pneumatic cylinders arranged between the first arm section 20 and the second arm section 21. The locking system is configured to receive a position from the camera 4 and/or the actuation system 6 and configured to activate itself when the camera is away from the idle position, i.e. out of the housing 32. The locking system 8 is configured to, upon activation, close valves in the pneumatic cylinder to block movement thereof, such that the inspection unit is locked with respect to the manlid opening. Additionally or alternatively, the sensor unit 33 may be provided with a movement sensor, such as an accelerometer, configured to measure a movement signal representative for movement of the inspection unit.

The inspection system 1 comprises a recognition system 9 configured to recognize a mobile tank identifier. The recognition system 9 is, in this embodiment, arranged on an upright 11 and comprises a number plate camera, such that, when a trailer passes the recognition system 9, a vehicle identification number and/or a container identification number may be recognized with the camera. The recognition system may also be arranged elsewhere.

The recognition system 9 is operatively connected to the contamination detector 5 and is configured associate the recognised identifier with the captured footage, in particular with the contamination signal.

The cleanliness inspection system is configured to determine a tank type and to determine the multiple predefined measurement directions D1, D2, D3, D4 in dependence of the determined tank type. The tank type may be retrieved from an information source, e.g. a database, and/or may be input by an operator, e.g. via a control interface 7, and/or may be determined automatically, e.g. by measuring dimensions of the tank and/or on the basis of the mobile tank identifier recognized by the recognition system. As different tank types may be provided with different types of interior, e.g. baffles, bulkhead dividers, piping, inlets and/or outlets, the contamination risk areas may vary with tank type.

The pneumatic cylinder is configured to damp motion of the second arm section 21 with respect to the first arm section 20. This way, the support structure 2 is constructed as a swivelable balanced top loading arm that may be moved vertically and horizontally with relatively little force. By having a balanced top loading arm, the inspection unit 3 may be aligned with a manlid opening 97 relatively easily to speed up the inspection procedure.

In use, a mobile transport tank 98 is positioned at a tank parking location near the gantry 10. A mobile tank identifier is recognized by the recognition system 9.

A user may then position the inspection unit 3 above a manlid opening 97 of the transport tank 98. A user may walk on the walkway 12 to open the respective manlid 97 and to subsequently move the inspection unit 3. As the support structure 2 is a balanced loading arm, movement of the inspection unit 3 is relatively easy. The aligner 31 is then positioned on the manlid opening 97, aligns the inspection unit 3 therewith, and covers the manlid opening to limit intrusion of light.

Via the control interface 7, the user starts cleanliness inspection. The locking system is then activated 8 to block movement of the support structure 2 and the actuation system 6 is activated to move the camera 4 from the idle position, in which the camera is arranged in the inner space of the housing 32 into the inspection position I, in which the camera protrudes through the manlid opening 97 and which is based on the mobile tank identifier.

The fluid level protector 31 determines a fluid level in the container 98 with level sensor 35 to block movement of the camera 4 when the fluid level is higher than the inspection position I.

The orientation compensation unit 34 measures an orientation of the mobile transport tank 98 and the camera 4 adjusts the predefined measurement directions D1, D2, D3, D4 on the basis of the orientation signal and the mobile tank identifier, and then captures photos from the inspection position in the measurement directions D1, D2, D3, D4, associated with a contamination risk area in the mobile transport tank.

Simultaneously, a tank wall temperature is measured with the temperature sensor, and a residual gas concentration is determined with the gas sensor.

The camera 4 may be connected wirelessly to a wireless transceiver (not shown) and/or via cable 61.

The photos, the tank wall temperature the residual gas concentration and the fluid level determined by the fluid level protector 31 are received by the contamination detector 5 via a wireless mobile phone network connection with the wireless transceiver. In other embodiments, the contamination detector 5 may be connected to the camera 4 via a wired connection.

The contamination detector 6 analyses the footage to detect contamination, such as moisture, in particular, condensation on walls of the mobile transport tank and/or fluid accumulation at a vertical tank baffle or tank end wall, in the mobile transport tank on the basis of the captured footage. Then, a contamination signal representative for the detected contamination is provided and stored in the logging unit.

Upon inspection, the actuation system 6 moves the camera back into the idle position and the locking system is deactivated to allow movement of the support structure 2.

When the contamination signal does not exceed a predetermined threshold, a filling approval may be provided on the control interface 7, for example a green tick or sound. Additionally, the captured footage may be provided to the user, for example on the control interface 7. The control interface 7 may ask the user to check the captured footage and/or the filling approval.

When the contamination signal exceeds the predetermine threshold, previous tank content data may be retrieved, and subsequent tank content data may be provided, which steps are for example performed by the contamination detector; such as from a database or by requesting input via interface 7. The contamination detector 5 may then still provide a filling approval even if the contamination signal exceeds the predetermined threshold, on the basis of compatibility of the previous tank content data and the subsequent tank content data. In case no filling approval is provided, the tank may need to undergo additional cleaning before filling.

The user may remove the inspection unit 3 from the manlid opening 97 and position a fluid loading arm to start loading fluid into the mobile transport tank or to perform inspection form another manlid opening 97.

Alternatively, inspection may be performed subsequently or simultaneously via another manlid opening 97.

The contamination signal may for example be stored with the mobile tank identifier.

Using the above procedure, the filling approval and/or the contamination signal may be logged. Further, inspection may be performed automatically and does no longer depend on human vigilance, i.e. awareness of the user of the inspection system. And therewith contributes to relatively fast, precise, and consistent assessment of cleanliness in the mobile transport tank 98.

The filling approval and contamination signal are now determined objectively and logged, such that human error or tampering can be avoided.

1. A cleanliness inspection system for inspection of an inner space of mobile transport tanks, such as tank containers, tank trailers and tank wagons, comprising:
a support structure; and
an inspection unit, connected to the support structure, comprising an aligner to be aligned with an opening of a mobile transport tank, a housing and a camera, wherein the camera is movable with respect to the support structure between an idle position, in which the camera is arranged within the housing and an inspection position, in which the camera extends at least partially from the housing such that the camera protrudes through the opening to capture footage of an inner space of a mobile transport tank upon alignment of the aligner with the opening,
wherein the cleanliness inspection system further comprises:
a contamination detector, operatively connected to the camera,
wherein the camera is configured to, in the inspection position, capture footage in predefined measurement directions associated with a contamination risk area in a mobile transport tank, and
wherein the contamination detector is configured to determine foreign contamination, such as moisture or fluid residue, in the mobile transport tank on the basis of the captured footage, and to provide a contamination signal representative for the determined contamination.

2. The cleanliness inspection system according to claim 1, wherein the camera comprises a lens and a condensation reduction device configured to prevent and/or reduce condensation on the lens when the camera is moved into the inner space.

3. The cleanliness inspection system according to claim 1, wherein the camera comprises a polarising filter configured to filter captured footage at a filter angle.

4. The cleanliness inspection system according to claim 3, wherein the inspection unit comprises a light source configured to emit light polarised in a polarisation angle and wherein a difference between the polarisation angle and the filter angle is 5°-65°, for example, 15°-45°.

5. The cleanliness inspection system according to claim 1, wherein the cleanliness inspection system is configured to provide a filling approval for the mobile transport tank when the contamination signal is below a predefined threshold.

6. The cleanliness inspection system according to claim 1, wherein the camera is configured to, in the inspection position, capture footage in multiple predefined measurement directions that are associated with multiple contamination risk areas in the mobile transport tank, wherein, for example, the camera, from the inspection position, is configured to capture footage in measurement directions that are opposite to each other with respect to a vertical symmetry plane that is perpendicular to the longitudinal direction of the tank
and/or
wherein, for example, the cleanliness inspection system is configured to determine a tank type, and wherein the cleanliness inspection system is further configured to determine the multiple predefined measurement directions in dependence of the determined tank type.

7-8. (canceled)

9. The cleanliness inspection system according to claim 1, wherein the contamination detector is configured to determine condensation on walls of a mobile transport tank on the basis of the captured footage as contamination, wherein, for example, the camera is configured to capture footage in an upward measurement direction, and wherein the contamination detector is configured to determine condensation on an upper or side tank wall.

10. (canceled)

11. The cleanliness inspection system according to claim 1, wherein the camera is configured to capture footage in a substantially horizontal measurement direction wherein the contamination detector is configured to determine fluid accumulation or objects at a vertical tank baffle or tank end wall.

12. The cleanliness inspection system according to claim 1, wherein the aligner has a conical shape adapted to mate to a contour of a standard mobile tank opening, for example, to mate to the contour in such a way that passing of light through the opening is limited when the camera is in the inspection position, for example, such that passing of light is substantially avoided, wherein, for example, the minimum diameter of the aligner is smaller than an outer diameter of the camera and wherein the aligner is provided with at least one recess to allow the camera to move through the aligner, for example, wherein the minimum outer diameter is 0.3 m or less.

13. (canceled)

14. The cleanliness inspection system according to claim 1, comprising an actuation system, operatively connected to the housing and configured to move the camera between the idle position and the inspection position, wherein the cleanliness inspection system comprises a control interface, configured to receive operator input to activate the actuation system to move the camera to the inspection position upon receiving the operator input, and configured to activate the actuation system to move the camera back to the idle position after capturing footage, wherein the control interface is arranged on the support structure and/or on the inspection unit,
wherein, for example, the control interface is configured to provide the contamination signal and/or a filling approval.

15. (canceled)

16. The cleanliness inspection system according to claim 1, further comprising a locking system, configured to lock of the inspection unit with respect to the opening when the camera is in the inspection position.

17. The cleanliness inspection system according to claim 1, further comprising a recognition system configured to recognize a mobile tank identifier, such as a container identification number, vehicle identification number and/or wagon identification number, and to associate the recognised identifier with the captured footage.

18. The cleanliness inspection system according to claim 1, wherein the inspection unit comprises a temperature sensor, such as a pyrometer, configured to measure a temperature signal representative for a tank wall temperature, for example, wherein the contamination signal is dependent on the temperature signal.

19. The cleanliness inspection system according to claim 1, wherein the inspection unit comprises a gas sensor configured to measure a residual gas concentration in a mobile transport tank, wherein the cleanliness inspection system is configured block provision of a filling approval for the mobile transport tank when the residual gas concentration exceeds a predetermined concentration.

20. The cleanliness inspection system according to claim 1, further comprising an orientation compensation unit configured to provide an orientation signal representative for an orientation of a mobile transport tank with respect to the aligner, wherein the cleanliness inspection system is configured to adjust the at least one predefined measurement direction on the basis of the orientation signal.

21. The cleanliness inspection system according to claim 1, further comprising a fluid level protector configured to measure a fluid level signal representative for a fluid level in the movable transport tank, wherein the fluid level protector is configured to activate movement the camera towards the idle position and/or to block movement of the camera towards the inspection position when the fluid level signal exceeds a predetermined fluid level threshold.

22. The cleanliness inspection system according to claim 1, wherein the support structure is constructed as a fluid loading arm, for example, a balanced top fluid loading arm.

23. A loading gantry for mobile transport tanks, such as tank containers and tank trailers, comprising:
a walkway positioned at least partially above a mobile transport tank parking location allowing operators to reach an opening of a mobile transport tank positioned on the transport tank parking location; and
a cleanliness inspection system according to claim 1.

24. Use of a cleanliness inspection system according to claim 1 for determining whether a tank has been cleaned according to predetermined standards.

25. A method for cleanliness inspection of mobile transport tanks, such as tank containers and tank trailers, comprising the steps of:
providing an inspection unit having an aligner, a housing and a camera connected to a support structure;
aligning the aligner of the inspection unit with an opening of a mobile transport tank;
moving the camera of the inspection unit from an idle position, in which the camera is arranged in an inner space of the housing into an inspection position, in which the camera protrudes through the opening;
capturing footage with the camera from the inspection position in measurement directions associated with a contamination risk area in the mobile transport tank;
determining foreign contamination, such as moisture, in the mobile transport tank on the basis of the captured footage; and
providing a contamination signal representative for the determined contamination; for example, further comprising the step of providing a filling approval for the mobile transport tank when the contamination signal is below a predefined threshold;
and/or,
for example, further comprising the steps of:
retrieving previous tank content data;
providing subsequent tank content data;
providing a filling approval for the mobile transport tank when the contamination signal exceeds the predetermined threshold on the basis of previous tank content data and subsequent tank content data;
and/or
wherein, for example, the step of determining contamination comprises determining condensation on walls of the mobile transport tank on the basis of the captured footage and/or determining fluid accumulation at a vertical tank baffle or tank end wall on the basis of the captured footage;
and/or,
for example, using the cleanliness inspection system according to claim 1.

26-30. (canceled)
